(19) United States
(12) Patent Application Publication
(10) Pub. No.: US 2010/0065439 A1
(43) Pub. Date: Mar. 18, 2010

(54) Method of Operating a Capacitive Deionization Cell Using a Relatively Slow Discharge Flow Rate

(76) Inventor: James P. Sullivan, Lincoln University, PA (US)

Correspondence Address: GORE ENTERPRISE HOLDINGS, INC., 551 PAPER MILL ROAD, P. O. BOX 9206, NEWARK, DE, 19714-9206, US

(21) Appl. No.: 12/557,558

(22) Filed: Sep. 11, 2009

Related U.S. Application Data
(60) Provisional application No. 61/096,904, filed on Sep. 15, 2008.

(51) Int. Cl. C02F 1/461

(52) U.S. Cl. 205/748

(57) ABSTRACT

A method of operating a capacitive deionization cell using a relatively slow discharge flow rate.

### CROSS REFERENCE TO RELATED APPLICATION

This application claims the benefit of commonly owned and co-pending U. S. Provisional Application No. 61/096,904 filed on Sep. 15, 2008.

### BACKGROUND OF THE INVENTION

Capacitive deionization (CDI) cells are known for purifying or otherwise deionizing liquids such as water. For example, U.S. Pat. No. 5,954,937 discloses an electrically regeneratable electrochemical cell for capacitive deionization and electrochemical purification and regeneration of electrodes including two end plates, one at each end of the cell. Two end electrodes are arranged one at each end of the cell, adjacent to the end plates. An insulator layer is interposed between each end plate and the adjacent end electrode. Each end electrode includes a single sheet of conductive material having a high specific surface area and sorption capacity. In one embodiment of this disclosure, the sheet of conductive material is formed of carbon aerogel composite. The cell further includes a plurality of generally identical double-sided intermediate electrodes that are equidistally separated from each other, between the two end electrodes. As the electrolyte enters the cell, it flows through a continuous open serpentine channel defined by the electrodes, substantially parallel to the surfaces of the electrodes. By polarizing the cell, ions are removed from the electrolyte and are held in the electric double layers formed at the carbon aerogel surfaces of the electrodes. As the cell is saturated with the removed ions, the cell is regenerated electrically, thus minimizing secondary wastes.

U.S. Pat. No. 6,709,560 discloses flow-through capacitors that are provided with one or more charge barrier layers. Ions trapped in the pore volume of flow-through capacitors cause inefficiencies as these ions are expelled during the charge cycle into the purification path. A charge barrier layer holds these pore volume ions to one side of a desired flow stream, thereby increasing the efficiency with which the flow-through capacitor purifies or concentrates ions.

These references all produce useful CDI cells, but a CDI cell that performs better is still needed. It is desirable in a CDI cell to maximize the amount of water cleaned per unit area electrode.

As used herein, “effective capacitance” means dQ/dV for a membrane-electrode conjugate as determined by current interrupt as described herein.

Also as used herein, “durability” means hours until ion removal is less than 60% (under test conditions specified herein).

### SUMMARY OF THE INVENTION

The present invention provides a method for efficiently softening water comprising:

(a) Assembling a cell comprising a cathode current collector, a first electrode capable of absorbing ions, a cation selective membrane, a spacer, an ion selective membrane, a second electrode capable of adsorbing ions, and an anode current collector;

(b) Collecting of a stream of clean water at a flow rate of F1, while applying a charge voltage of between about 0.5V and about 1.3V between said cathode current collector and said anode current collector for a first period of time, T1

(c) Collecting a stream of waste water at a second flow rate, F2, while applying a discharge voltage between about −1.3 and about −0.5 V between said cathode current collector and said anode current collector for a second period of time, T2, such that

T2 is greater than or about equal to 1−[T1*F1/(T1*F1+T2*F2)]*[T1+T2] and T1*F1/(T1*F1+T2*F2) is greater than or equal to about 0.7.

### DESCRIPTION OF THE DRAWINGS

FIG. 1 is an exploded view of an exemplary embodiment of the invention.

FIG. 2a is a cross sectional view of an assembled CDI cell according to an exemplary embodiment of the invention before compression.

FIG. 2b is a cross sectional view of an assembled CDI cell according to an exemplary embodiment of the invention after compression.

FIG. 3 is a schematic of the test apparatus used for CDI testing.

FIG. 4 is a graph of an Example test cycle illustrating TDS variation during the cycle.

FIG. 5 is a cross section of an exemplary CDI test cell showing the location of the reference electrode, (70).

FIG. 6 (reserved)

FIG. 7 is a graph of TDS vs time.

FIG. 8 is a graph of current versus time.

### DETAILED DESCRIPTION OF THE INVENTION

Applicants have discovered that a relatively slower flow rate during the discharge cycle of a CDI cell, in combination with proper balance of the time of the discharge cycle, provides for better overall efficiency. As used herein, “efficiency” means maximizing the amount of water cleaned per unit area electrode.

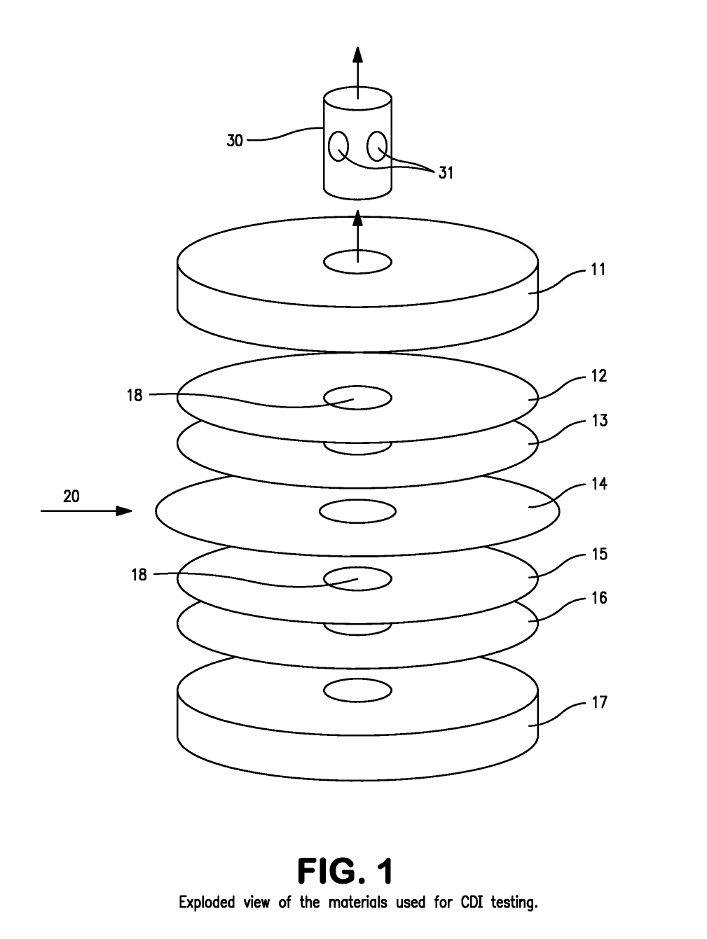

An exploded view of the inside of a CDI cell according to an exemplary embodiment of the present invention is illustrated schematically in FIG. 1. The cell consists of a stack of discs, consisting in order, of an anion electrode, 12, an anion selective membrane, 13, a woven spacer, 14, that serves as a fluid flow path, a cation selective membrane, 15, and a cation electrode, 16. The stack of materials is compressed between two conductive graphite carbon blocks (POLO Graphite, Inc.), 11 and 17, which serve as electrical contacts to the electrodes. During the charging, or purification cycle, the anion electrode contacting graphite carbon block, 11, is electrically connected to the positive terminal of the power supply. The cation electrode contacting graphite carbon block, 17 is connected to the negative terminal of the power supply. A plurality of such cells may be used, in series or in parallel, in alternative embodiments of the invention.

The anion and cation electrodes, (12) and (16) are cut from sheets, composed of activated carbon, conductive carbon black and a PTFE binder. Electrodes of this type are widely used in electric double layer capacitors. In these tests, electrodes of varying thickness were obtained from Japan Gore-Tex, Inc., Okayama, Japan. The dimensions of the electrodes in the cell of this embodiment are 3″ in diameter, and have a 0.5″ diameter hole (18) in the center to allow the treated water to pass out of the cell.

The anion membrane (13) is cut from sheets of NEOSEPTA AM1 (Amerida/ASTOM). The dimensions are 3″ OD with a 0.5″ ID. The cation membrane (15) is cut from sheets of NEOSEPTA CM1 (Amerida/ASTOM). The spacer, 14, is a 3.25″ OD×0.5″ ID disc cut from a 0.004″ woven polyester screen.

The flow of water into the cell is radial, with water entering the cell from the outside edge of the spacer, (14), and flowing out the center exit tube, (30). Holes (31) are positioned in the center exit tube to enable water to flow from the spacer into the tube.

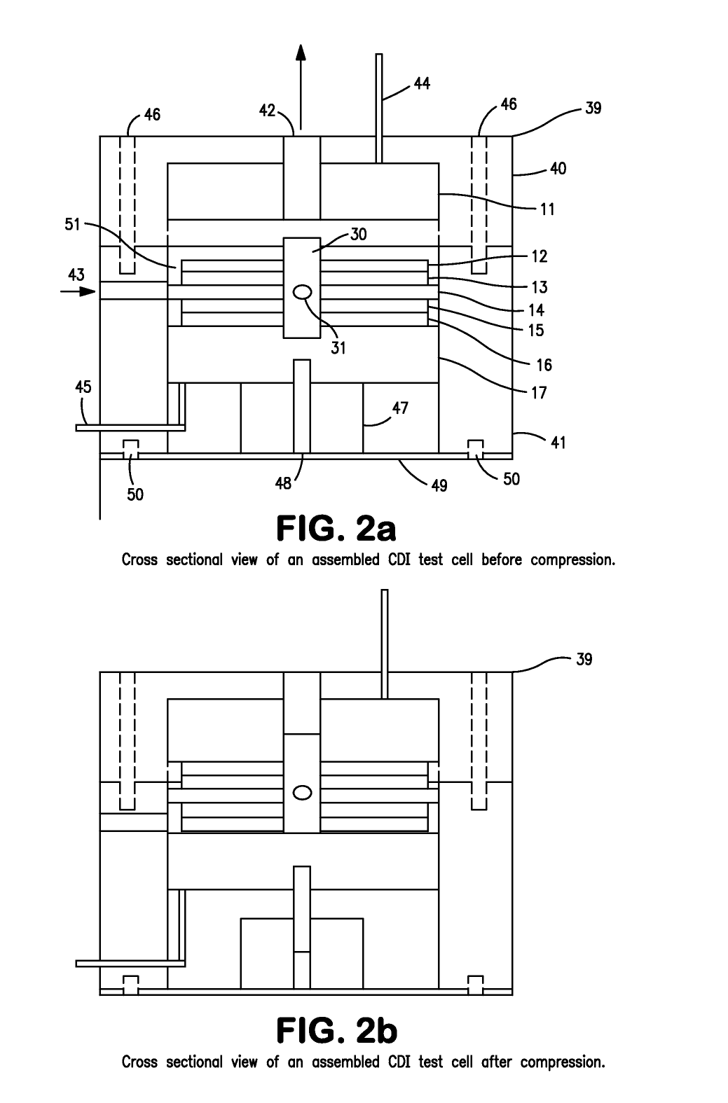

A cross section of exemplary cell components as assembled in an exemplary cylindrical cell housing, (39), are shown in FIG. 2a. The housing consists of a top half (40) and a bottom half (41), joined by means of 4 bolts (46). The cation contacting graphite carbon block, (17) is mounted to a pneumatically actuated air cylinder (47). The cell components, 12-16 are stacked on top of the carbon block (17), and around the exit tube (30). The anion contacting carbon block (11), is rigidly mounted to the top half to the housing (40). Electrical leads 44 and 45 connect the anion contacting carbon block (11) and the cation contacting carbon block (17) to the power supply. Water is brought into the cell through the water inlet (43) and fills the circular cavity (51) surrounding the cell components (12-16). The water flows radially through the spacer (14) and exits the cell via holes (31) in the exit tube (30) and the cell water outlet (42). The pneumatic cylinder is mounted to a base (49), which is attached to the bottom half of the housing (41) by means of bolts (50). The air cylinder piston (48) is mounted to the cation contacting carbon block 17. When the air cylinder is activated the air cylinder piston is extended from the air cylinder, raising (17) and compressing the cell assembly as shown in FIG. 2b.

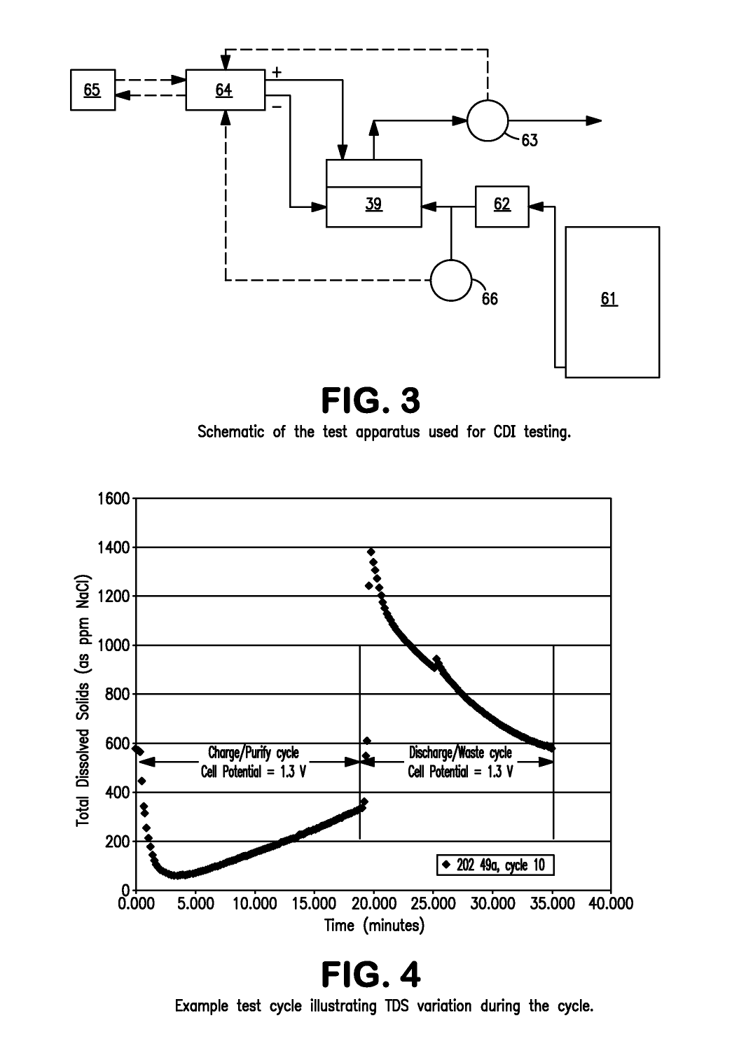

In operation of this exemplary embodiment, as shown in FIG. 3, water is pumped from a reservoir, (61), via a peristaltic pump (62) into the cell (39). Treated water is analyzed with a conductivity probe (63). The output of the conductivity probe is converted to total dissolved solids (TDS), based on a NaCl calibration. Power is applied to the cell by means of an programmable battery cycle tester (64)(ARBIN BT2000). Potential, current and conductivity are recorded as a function of time on a computer (65). The inlet pressure to the cell is monitored by an inlet pressure transducer (66), whose output can optionally be included in the ARBIN (64).

The cell TDS can be utilized as a set point by the battery cycle tester in the controlling charge and discharge cycles. Inlet water TDS is nominally 480 ppm. At the beginning of the charge cycle, the TDS rapidly declines to some minimum value (see FIG. 4). After reaching the minimum value, TDS increases slowly. Typically charge cycles are conducted until the product TDS reaches 320 ppm, at which point the polarity of the potential is reversed, causing the cell to discharge. There is a rapid increase in current and TDS on discharge. After reaching a peak, the TDS decreases and the discharge is typically allowed to proceed until the product TDS falls to 580 ppm.

### EXAMPLES

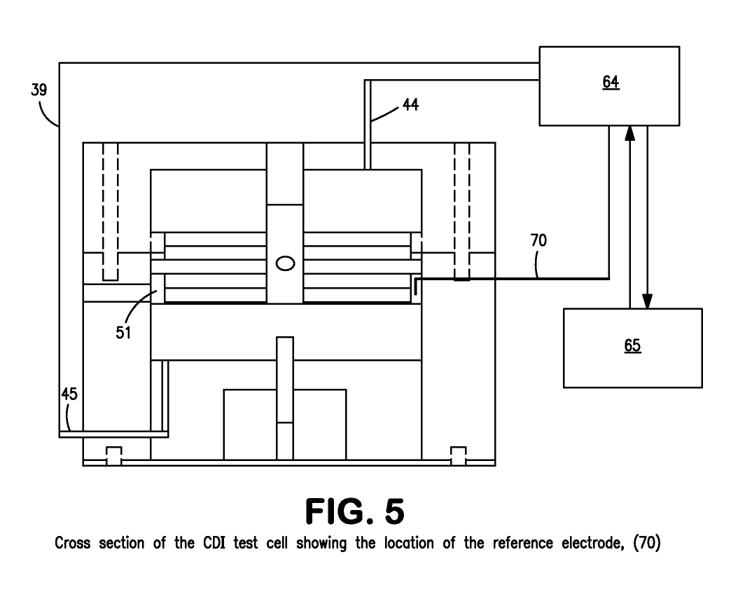

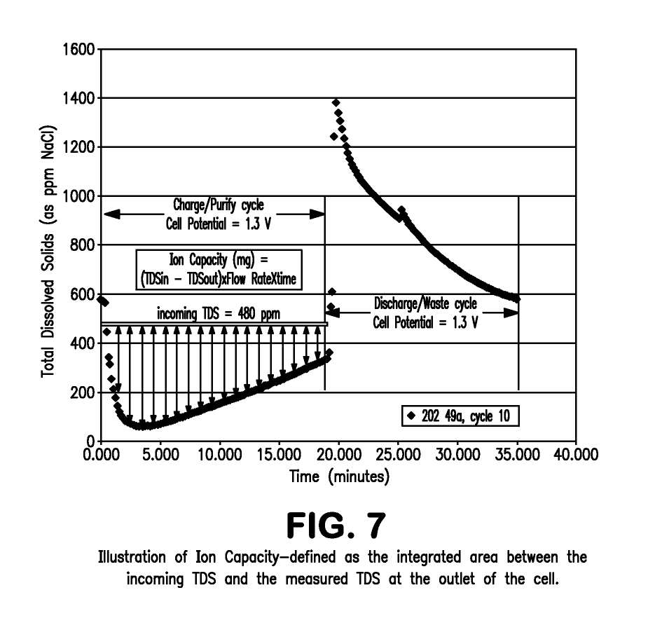

In some experiments it was considered useful to employ a Ag/AgCl reference electrode (see FIG. 5) (70) to determine how the potential split between the two electrodes. The position of the reference electrode is shown in FIG. 5. Positioned in the circular cavity (51) surrounding the cell components, the solution potential should be constant. The chloride activity of the test water was estimated to be 0.00356 M using Debye-Huckle approximations for the activity coefficient. From this activity, the potential of the reference electrode was determined to be 0.367V vs. the standard hydrogen electrode. Protocols could be programmed that enabled a short open circuit condition, or a so called current interrupt. This protocol enabled in-situ determination of the potential of each electrode, free of cell IR.

### Electrodes

Activated Carbon Electrodes in thicknesses of 800 micron, were obtained from Japan Gore-Tex. These electrodes are marketed commercially for electrolytic double layer capacitor, and particularly for coin cell applications.

### Membranes

Cation Membrane was GORE SELECT (GS018950-44us) produced by W. L. GORE & Associates, Inc. Anion membrane was FUMASEP FAB 30 um non-brominated (lot MI0507-140), obtained from FUMATECH GmbH.

### Spacer

The spacer was a woven polyester screen, 0.004″ thick, 180 threads per inch, PETENYL, obtained from Tenyl Tecidos Técnicos Ltda, Brazil.

Test water

A test water made to simulate a “hard” tap water was formulated using the following recipe.

| | |
|---|---|
| Calcium chloride dehydrate | 293.6 mg/L |
| (CaCl2•2H2O) | |
| Sodium bicarbonate (NaHCO3) | 310.7 mg/L |
| Magnesium sulfate heptahydrate | 246.5 mg/L |
| (MgSO4•7H2O) | |

The resulting water had a total hardness of 300 mgCaCO3/L, calcium hardness of 200 mg/L, alkalinity 185 mg CaCO3/L and a pH of approximately 8.0.

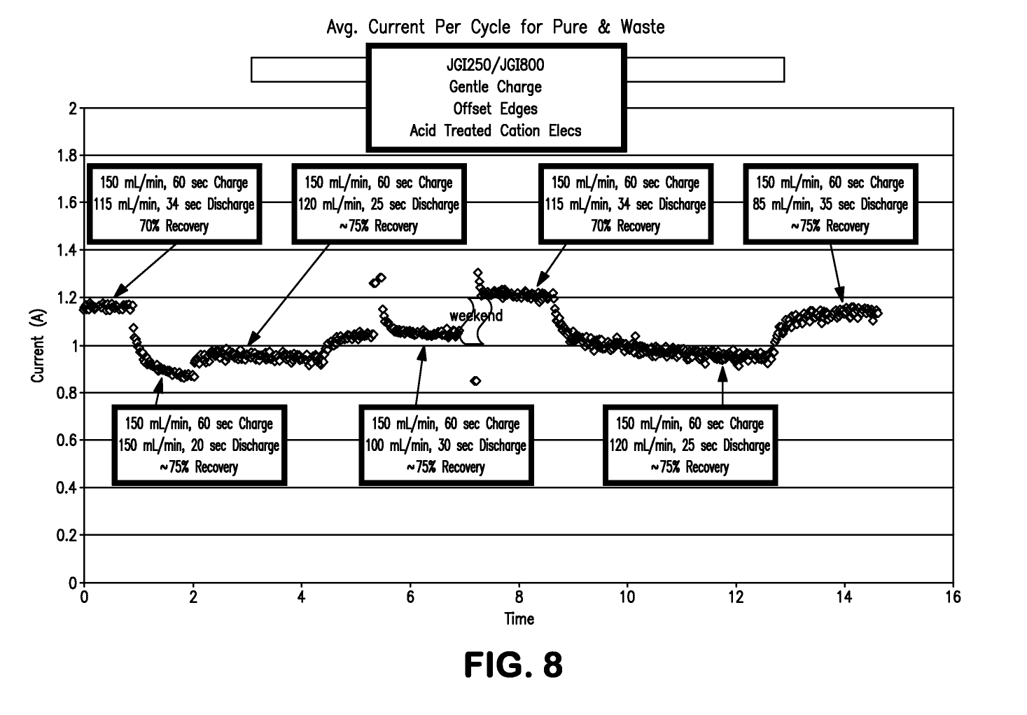

A graph showing the current versus time for a variety of operating conditions within the scope of this disclosure is shown in FIG. 8. The graph indicates that the slower flow rates on discharge yield efficient CDI cell performance.

While particular embodiments of the present invention have been illustrated and described herein, the present invention should not be limited to such illustrations and descriptions. It should be apparent that changes and modifications may be incorporated and embodied as part of the present invention within the scope of the following claims.

The invention claimed is:

1. A method for efficiently softening water comprising:
(a) Assembling a cell comprising a cathode current collector, a first electrode capable of absorbing ions, a cation selective membrane, a spacer, an ion selective membrane, a second electrode capable of adsorbing ions, and an anode current collector;
(b) Collecting of a stream of clean water at a flow rate of F1, while applying a charge voltage of between about 0.5V and about 1.3V between said cathode current collector and said anode current collector for a first period of time, T1
(c) Collecting a stream of waste water at a second flow rate, F2, while applying a discharge voltage between about −1.3 and about −0.5 V between said cathode current collector and said anode current collector for a second period of time, T2, such that
T2 is greater than or about equal to 1−[T1*F1/(T1*F1+T2*F2)]*[T1+T2] and T1*F1/(T1*F1+T2*F2) is greater than or equal to about 0.7.
